(19) United States
(12) Patent Application Publication
(10) Pub. No.: US 2008/0114543 A1
(43) Pub. Date: May 15, 2008

(54) MOBILE PHONE BASED NAVIGATION SYSTEM

(75) Inventor: Guruswamy Sunderam Vishnu, Bangalore (IN)

Correspondence Address: LOUIS VENTRE, JR, 2483 OAKTON HILLS DRIVE, OAKTON, VA, 22124-1530, US

(73) Assignee: INTERCHAIN SOLUTION PRIVATE LIMITED

(21) Appl. No.: 11/938,340

(22) Filed: Nov. 12, 2007

(30) Foreign Application Priority Data
Nov. 14, 2006 (IN) 2109-CHE-2006

(51) Int. Cl. G01C 21/02; G01C 21/30; G01C 21/00

(52) U.S. Cl. 701/209; 701/213; 701/208; 701/207

(57) ABSTRACT

A mobile phone based navigation system is disclosed. An application when installed in the mobile phone enables the use of mobile phone as a navigation system. The application can adjust to various features of the mobile phone and utilizes phone memory or external memory to store the navigational information and maps. The mobile phone with the application installed inside can obtain positional information containing signals transmitted both from GPS satellites as well as the mobile towers. The application uses positional information to obtain navigational information. The positional and navigational information are processed by the application to obtain location information of the user. The application utilizes a user interface, which is the mobile phone display, to interact with user and display the location information.

### FIELD OF INVENTION

The present invention relates to navigation systems. More specifically it relates to method and system for enabling the use of a mobile phone for navigation purposes.

### BACKGROUND OF THE INVENTION

A navigation device used in a vehicle generally comprises of a map data storage device having map data recorded in it, a vehicle-movement detector for detecting the vehicle position, a Global Positioning System (GPS) receiver, a velocity sensor, and a display to communicate navigational information to the user. The navigation device reads map data for an area including the current position of the vehicle from the map-data storage device, draws a map image of an area around the current position of the vehicle based on the map data and shows the location of the vehicle on the map image. In accordance with movement of the vehicle, the navigation device scrolls the map image, or moves the vehicle position with the map image remaining fixed on the screen, thus allowing a user to recognize the movement of the vehicle.

The main disadvantage of the abovementioned navigation device is that the data displayed to the user and the data used for processing is static in nature. The device does not communicate in real-time to external data sources so it is not possible to capture live information to and from the user. They sometimes support offline refreshing of the database that is done in discrete intervals of time, which is inconvenient and costly for the user. Moreover, this offline refreshing restricts the scope of the device from providing services like live traffic, emergency updates, location of other users, etc. Also storing all the data onto the device introduces a limitation on the depth and the span of information that can be housed. For example, it is not practical to encompass maps, to the highest detail, of the entire world onto the device. They also cannot leverage alternate location data sources like broadcasting tower based location approximation services.

Mobile phone based navigation devices have helped in solving the above problem associated with the traditional navigation devices. Mobile phones are available with the user most of the time; hence the user need not carry an extra device in the form of a navigation device. The mobile phone based navigation system can take advantage of the cellular network to deliver real-time information such as traffic conditions and updated maps. These systems download each route or map to the mobile phone from a network server whenever a user requests for the map information. The information present in the network server is kept updated. This is a distinct advantage over the traditional navigation system in which each user has to keep updating the map database stored in their respective navigation device.

Most of the navigation devices, including mobile phone based devices, use Global Positioning System (GPS) for locating the position of the user. GPS is a satellite-based navigation system. Utilizing a constellation of at least 24 medium Earth orbit satellites that transmit precise microwave signals, the system enables a GPS receiver to determine its own location, speed and direction.

U.S. Pat. No. 5,043,736 issued Jul. 27, 1990 combines the capabilities of GPS device and Mobile phone in a single device. The patent discloses a system for vehicle monitoring that has a GPS receiver configured inside a mobile phone. The signal received by the receiver is subsequently transmitted to a base unit that translates the GPS signal into latitude and longitude data. This information gives an operator in the base unit the ability to track the location of the mobile telephone and, accordingly, the vehicle in which the mobile telephone is placed. Such systems, however, are bulky and complex.

U.S. Pat. No. 5,786,789 issued Nov. 14, 1994 discloses a device that overcomes the limitations of cost, complexity and bulkiness of devices that combine GPS and mobile functionalities. The device also allows consumers to selectively enable mobile or GPS functionality.

Later developments made it possible to automatically report mobile phone location in terms of street address and other non-traditional location formats instead of in terms of latitude and longitudes.

In further developments, Enhanced 911 or E911 service (North American telephone network (NANP) feature) has provided phones with a capability known as automatic location identification (ALI) for translating the telephone number of the caller to a street address. In more recent times, a capability known as geocoding has enabled E911 centers to convert a street address determined by ALI into a geodetic location, such as latitude and longitude, and to display a map of the local area about the street address to the dispatcher. The most advanced E911 installations have the capability of tracking the mobile locations of emergency vehicles that are available or proceeding to the scene of emergency.

The increasing use of both portable radios and GPS receivers led to the combining of two units. Such combined units provided enhanced capabilities such as the ability to transmit GPS-derived location data between two or more units so that the users of the units could monitor each other's location. For example, a family could use several of these combined units not only to communicate amongst family members but also to monitor location of the members so that parents could keep track of their children. In short it made communication easier and effective.

GPS receiver devices with map display capability could store the map information on computer diskettes, CD-ROM's, or other computer memory storage devices. The device location could then be displayed on a display terminal with reference to a map stored in the computer memory storage device. The huge amount of map data, however, could overwhelm the memory capability of portable computer devices. To reduce the need for large storage spaces U.S. Pat. No. 6,924,748 issued Dec. 9, 2002, discloses a location tagged data provision and display system. The patent discloses a personal communication device with a GPS receiver and a display. The device has the capability to request maps and location tagged data from data providers for display on the user screen. The data providers respond to requests by using searching and sorting schemes to interrogate databases and then automatically transmit data responsive to the requests of the requesting device.

Presently many companies have come with mobile phone based navigation devices. Taken together, the existing mobile phone based navigation devices have covered wide variety of features like vehicle navigation, family and friend finding, buddy grouping, position sensitive chatting, mobile matchmaking, mobile location blogging, geo-marked photo sharing, interactive gaming, pet finding, personal safety usage, roadside assistance, emergency services, weather warnings, fleet management, location triggered advertising, sales force automation, theft detection, work force management, tour guiding, local searching etc.

However, the abovementioned references have one or more of the following limitations. Most of these products are based on sources like GPS technology or mobile phone tracking technology but they do not allow a user to obtain position information from one of the available sources or a combination of these sources. They also do not give the user the information on the position information providers, like the satellite used to get the position or the mobile towers used to get the position. Further they do not provide comprehensive emergency services, for example, transmitting post accident information like location of the accident to the rescue workers. Also, they either lack or have limited capability in filtering the messages containing errors from the GPS source. Furthermore, they do not allow the user to select his/her own location provider and overlay information from multiple providers. Some of these products provide traffic information services but it is based on external traffic information system and not by leveraging the peer user data. This makes it very costly to get these services. Also these products are normally not compatible with most phones. The existing mobile based navigation products also do not offer information connected to the energy spent, time and other statistics in the activities like walking, jogging or any sport activity. The existing mobile based navigation products also do not offer time to speed measurements on a device such as mobile phone. The existing mobile-based navigation products also do not offer acceleration measurement on a mobile device. The existing mobile-based navigation products also are also not capable of collecting survey standard data used for creating electronic and physical maps. The existing products also support only two dimensional representation of the map data and do not use the third dimension, the altitude parameter, in showing roads, terrains, buildings and other features on the map.

Therefore, there is a need for a navigation system using mobile phones which overcomes these limitations. Further, there is a need for a comprehensive navigation system which can provide one interface to the mobile phone users for dealing with all navigation related applications.

### BRIEF SUMMARY OF THE INVENTION

A system and a method for a mobile phone based navigation device is disclosed. The invention comprises an application which when installed in a mobile phone, enables the use of mobile phone as a navigation device. The application can adapt to various features of the mobile phone.

The application, when installed in the mobile phone, interacts with positional information receivers like GPS and mobile towers and collects positional information. The positional information is used by the application to collect navigational information on the mobile phone. The navigational information could be collected from phone memory or from an external provider, to provide navigational help to the user. The positional information and the navigational information is displayed to a user on a user interface, which may be the mobile phone display.

Several mobile phones, each equipped with the application, can be connected with each other via a central station. The mobile phones, thus connected with each other, can share positional information and the navigational information with each other as well as a third party. The central station may be the source for collection of navigational information by the mobile phone.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a diagram depicting the basic uses of the invention according to an embodiment of the invention.

FIG. 2 is a detailed block diagram of system and its environment according to an embodiment of the invention.

FIG. 3 is a diagram discussing the general system elements according to an embodiment of the invention.

FIG. 4 is a flow diagram discussing an approach for using system for navigation according to an embodiment of the invention.

FIG. 5 is a flow diagram discussing an approach for using system in connection with other such systems in accordance with an embodiment of the invention.

### DETAILED DESCRIPTION

In the following description, for the purposes of explanation, specific details are set forth in order to provide a thorough understanding of the invention. However, it will be apparent that the invention may be practiced without these specific details. Various aspects and features of example embodiments of the invention are described in more detail hereinafter.

A system and a method for mobile phone based navigation are disclosed. The invention comprises an application which, when installed in a mobile phone, enables the use of the mobile phone as a navigation device. The application can adapt to various features of the mobile phone. For example, if there is an inbuilt BLUETOOTH in the mobile phone, the application can use BLUETOOTH to collect information from an external source. In the absence of BLUETOOTH, the application looks for other alternative technologies in the mobile phone to enable collection of information from an external source. Similarly on a phone with touch screen support, the application enables the user to use touch screen support for performing operations like panning maps, zooming maps, searching for destination and navigating menus. More examples of application adapting to the mobile phone features have been discussed in the disclosure.

The application, when installed in the mobile phone, interacts with a positional information receiver available with the mobile phone and collects positional information from a source of positional information. The positional information received can include, latitude longitude information, distance to particular points, relative distance between two points, altitude, speed, direction of travel, direction of facing. Some positional information will also be derived from the information collected such as acceleration, bearing to a particular destination, distance traveled, etc. An example of the positional information receiver is a GPS receiver. The positional information is used by the application to collect navigational information on the mobile phone. Navigational information could be maps, routes to near by areas, distances to near by areas, photographs, images, satellite images, key statistics, specialties of current location, places to visit, shops around, emergency services of in and around areas and locations. The positional information and the navigational information are processed by the system to collect location information. The location information is displayed to a user on a user interface, which is the mobile phone display, to provide navigation related assistance.

Several mobile phones, each equipped with the application, can be connected to each other via a central station. The mobile phones, thus connected with each other, can share positional information and the navigational information with each other as well as a third party. In an alternate embodiment, the central station may be a source of the navigational information and may provide this information to the mobile phones.

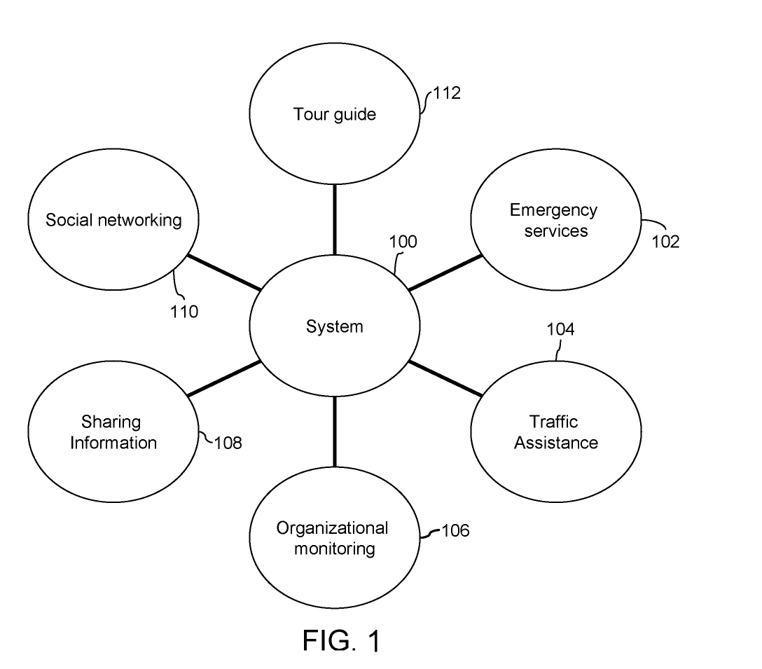

FIG. 1 illustrates various applications of the present invention. System 100 is a mobile phone with the application installed inside the mobile phone. A user in the disclosure implies a user of system 100.

System 100 can provide comprehensive navigation assistance to the user. System 100 can provide emergency services 102, traffic assistance 104, organizational monitoring 106, information sharing 108, social networking 110 and tour guiding 112.

System 100 is useful in providing emergency services 102 during navigation, for example predicting emergency situations like accidents. Also if an emergency like an accident is detected, system 100 can transmit positional information like the location of the accident to emergency services like 911 and third parties. System 100 can function as a black box and can provide positional and navigational information during the time of accident, for example the speed of the vehicle, the likely destination of the user etc. The invention can also trigger voice recording or camera recording features in case of the accident, which can be valuable information on the incident.

System 100 can provide traffic assistance 104 to the user. For example, the user can receive information regarding traffic density in a particular route and can plan the route for navigation.

Another use of the system 100 is for organizational monitoring 106. An organization can use system 100 for determining the location of, for example, sales representatives who are on calls.

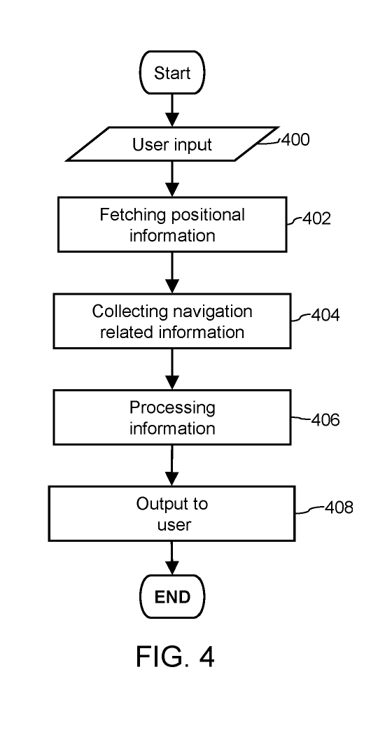

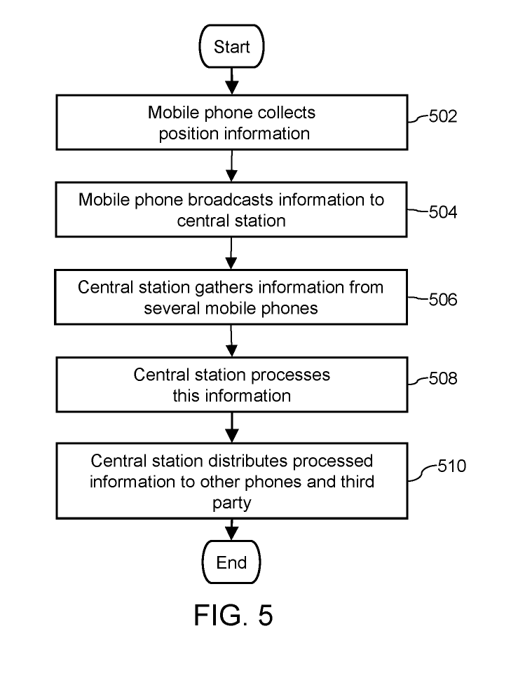

System 100 can be used for sharing information 108 like trip data with friends and relatives. For example, using system 100, the route taken for a trip like trekking can be traced in a map and shared with friends. Additionally, system 100 can be used for social networking 110, like tracing the location of friends, sharing files with friends etc. and tour guiding 112. The tour guide feature of the invention has been explained in detail in conjunction with FIG. 4 while the features of information sharing, emergency services, traffic assistance and organizational monitoring have been explained in detail in conjunction with FIG. 5.

Hereinafter, the invention will be discussed with respect to a particular embodiment. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein maybe applied to other embodiments and applications without departing from the spirit and scope of the invention.

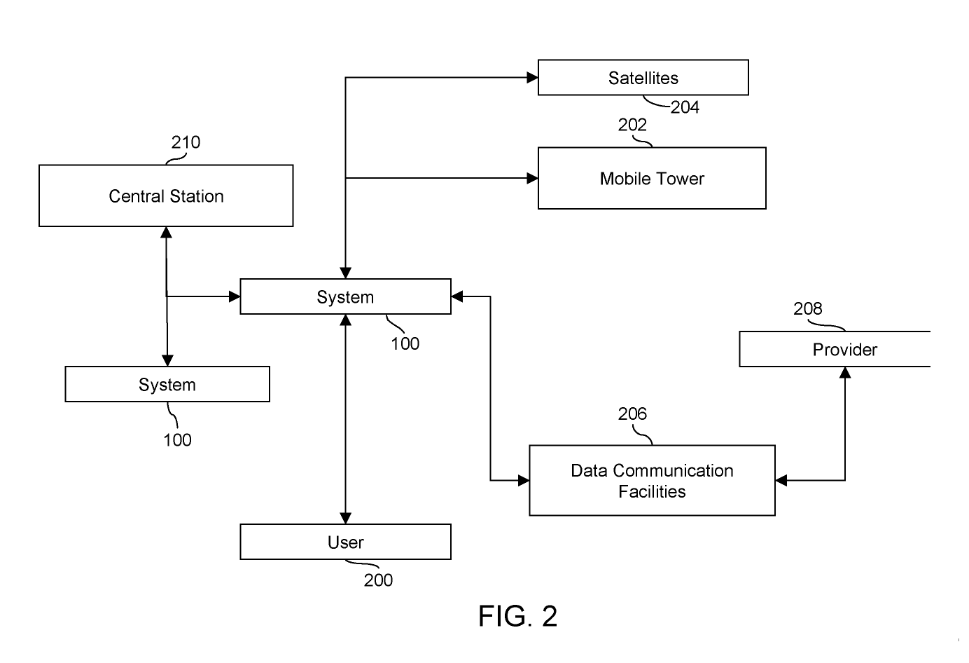

FIG. 2 is a block diagram illustrating system 100 and the environment in accordance with an embodiment of the invention.

System 100, as stated earlier, is a mobile phone with the application installed inside. System 100 is being used by a user 200. User 200 can receive positional information using system 100. The application installed inside the mobile phone interacts with the positional information receiver available with the mobile phone to collect positional information from a source of positional information such as GPS, mobile towers etc. The positional information receiver could be an external device, for example a GPS receiver, or an internal information source inbuilt in the mobile, for example an internal GPS or a device for approximating position using mobile towers. The other example of positional information receiver could be Assisted GPS (AGPS), wherein there is a partial GPS implementation on the mobile which uses cell tower information or operator assistance to decide upon the satellites 204 to be used for fixing the exact location. Another positional information receiver could be a device for capturing id of the mobile tower with which the mobile phone is connected. The id information can be used to approximate the current location/zone of the mobile phone. Various other means, apparent to persons skilled in the art can be deployed to collect positional information.

After getting the positional information, system 100 collects navigational information. Navigational information has been discussed in detail in conjunction with FIG. 4. System 100 is capable of utilizing data communication facilities 206 available on the phone like GPRS (General Packet Radio Service), EDGE (Enhanced GPRS), EVDO (Evolution-Data only) via the exposed Network Communication APIs and communicates with a number of providers 208 of such data like GOOGLE MAPS, YAHOO MAPS, MICROSOFT VIRTUAL EARTH, etc. to collect navigational information. System 100 is also capable of using Short Messaging Service (SMS) as a means to exchange information with provider 208. For example, system 100 can frame encrypted message containing the request and the provider can respond back with a SMS containing data like route, point of interest, local data etc. Various other means, apparent to persons skilled in the art can be deployed for collecting navigational information.

System 100 processes the positional information and the navigational information and collects the location information of the mobile phone. The processing of the positional information and the navigational information is discussed in detail in conjunction with FIG. 4. The location information is also discussed in detail in conjunction with FIG. 4. The location information is displayed to user 200 on a user interface, which could be the mobile phone display. System 100 is capable of displaying three-dimensional data.

Several systems like system 100 can be connected to each other and with a third party via a central station 210. The positional information and the navigational information can be shared between systems and with a third party via central station 210. Central station 210 can help in traffic assistance, organizational monitoring etc. for users 200 of system 100. The sharing and monitoring feature has been explained in detail in conjunction with FIG. 5. The communication between system 100 embedded in the mobile phone and central station 210 may be achieved using the mobile phone data communication infrastructure like GPRS, EDGE, CDMA1X and other upcoming technologies.

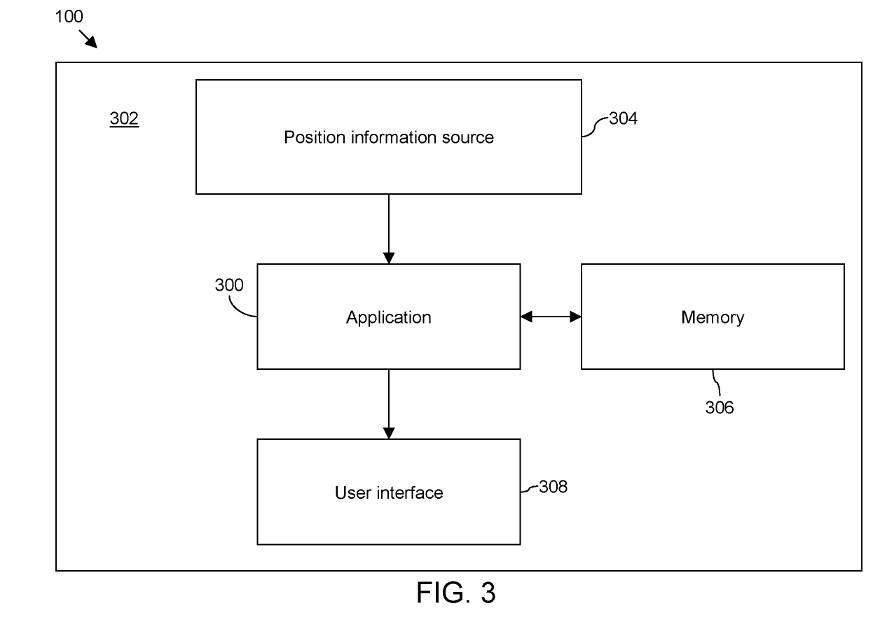

FIG. 3 is a diagram illustrating elements of system 100. Application 300 can be downloaded or transferred over the air using mobile network from source provider to a mobile phone 302. After application 300 gets installed on mobile phone 302, application 300 interacts with external positional information source 304 like a GPS receiver or internal positional information source 304 like inbuilt GPS or a device for approximating position using mobile towers 202. In the process of collecting information from the positional information receiver 304 or while collecting information like map, routes to near-by areas, distances to near-by areas, photographs, images, satellite images, key statistics, specialties of current location, places to visit, shops around, emergency services of in and around areas and locations, system 100 caches this data utilizing a memory 306. The memory may be internal memory of the mobile phone 302 or external memory such as flash memory, external memory card, etc. All the information is processed depending on user's query and the final output is shown to user 200 on a user interface 308. In one embodiment, user interface 308 is the display screen of mobile phone 302. Application 300 is also capable of storing and retrieving the collected information from its memory 306 or sharing it with other such system 100. In an embodiment, system 100 has a shock detector and a camera attached to it allowing the system to be useful for emergency situations like accidents.

FIG. 4 is a flow diagram illustrating the use of system 100 by user 200 in accordance with an embodiment of the invention. At step 400, user 200 gives an input to system 100 requesting for navigation related assistance. For example, when system 100 is being used for tour guiding, user 200 is provided with a search option to search for places or addresses about which user 200 wants more information. This information may include information related to distance, routes to be taken to reach the address, etc. In an embodiment, the request from user 200 is in the form of a specific request for the route between two locations. In an alternate embodiment, the request is in the form of a location query. The location query may include parameters denoting location identification information and need not be the exact address. An example of a location query could be pizza shops in 5 mile radius from the current location. System 100 may work automatically, fetching information without a specific request from user 200.

System 100, on receiving a request for navigation related assistance from user 200, collects positional information for user 200. Application 300 interacts with positional information receiver available with the mobile phone 302 to collect positional information from a source of positional information. System 100 collects positional information with the help of an external positional information receiver 304 like a GPS receiver or internal positional information receiver like inbuilt GPS receiver or a device for approximating position using mobile towers. Application 300 can adapt to the positional information receiver available with mobile phone 302.

The positional information may include, latitude longitude information, distance to particular locations, relative distance between two points, altitude, speed, direction of travel etc. Some positional information may also be derived from the collected information such as acceleration, bearing to a particular destination, distance traveled, etc. In one embodiment, the derived information may include distance calculated using Haversine formula. Haversine formula is an equation important in navigation and enables calculation of great-circle distances between two points on a sphere from the longitudes and latitudes of the points. Other derived data like the acceleration may be calculated using well known formulas.

With an external positional information receiver 304, system 100 establishes wired connection using serial protocol or wireless connection using BLUETOOTH communication protocol. Application 300 can be extended to work using advanced protocol like WiFi. From an external positional source 304, system 100 receives messages in common positional information transmission format like NMEA (National Marine Electronics Association). System 100 performs the decoding of the NMEA format on the mobile phone 302 platform.

With an internal positional information receiver 304, system 100 interacts via the internal positioning system exposed API (Application Programming Interface). System 100 uses JSR 179 (Java Specification Request) standard APIs to collect positional information from the internal positioning equipment. This format may be revised or modified from time to time.

System 100 generates a checksum for all the received messages and validates the generated checksum against the one that is embedded in the message, thus rejecting all the messages that could potentially contain errors. This is necessary because the data communication between external positional information receiver 304 and the mobile phone is vulnerable to errors such as connection time outs, corrupt messages etc.

The data from positional information receiver 304 might contain some spikes and surges which are not the actual representation of the real data. System 100 uses a simple smoothing function, which skips the values that deviate from the previous value by a very large extent. System 100 can use the cell tower ids to get the latitude, longitude range in which the cell is and avoids junk data from the GPS receivers outside this range. The smoothing algorithm is maintained simple in order to support the miniature platform of the mobile phone 302. As the platform becomes powerful, better smoothing algorithms may be implemented.

After getting the positional information, at step 402, system 100 collects navigational information related to the request by user 200 at step 404. Application 300, within system 100, collects the navigational information. Navigational information may include maps, routes to near-by areas, distances to near-by areas, photographs, images, satellite images, key statistics, specialties of current location, places to visit, shops around, emergency services of in and around areas and locations. The navigation related information could be available in memory 306 of mobile phone 302. Application 300 can collect the information from memory 306. Application 300 can also retrieve such information from similar systems 100 around. The retrieving of such information from other such systems might be done via a central station 210 or using wireless protocol such as BLUETOOTH. System 100 can also fetch such information from an external provider 208. System 100 is capable of utilizing data communication facilities 206 available on the phone like GPRS (General Packet Radio Service), EDGE (Enhanced GPRS), EVDO (Evolution-Data only) via the exposed Network Communication APIs and communicates with a number of providers 206 of such data like GOOGLE MAPS, YAHOO MAPS, MICROSOFT VIRTUAL EARTH, etc to collect the navigational information.

After the navigational information and the positional information has been collected, system 100, at step 406, processes the collected information based on user query and determines the location information. The processed positional and navigational information is referred to as the location information. The location information comprises of the answers for the user query. System 100 does initial processing to collect location information required to answer user query from the available navigational and positional information. Some of the processing done with positional information has been discussed above such as deriving more information like distance traveled and speed of the vehicle. Processing further involves customizing positional and navigational information before presenting the information to user 200. Thus for example, if the user query comprises of maps of a certain area, the system processes the maps of the area and stores the maps in the form of tiles applying Mercator projection rules before displaying the maps to user 200.

Using Mercator projection the cylindrical globe map is projected on to a two dimensional space such as paper or computer image. The whole two dimensional projection is broken into square tiles and images corresponding to these tiles housed by providers in some indexed fashion. So system 100 finds the tile which contains the current latitude and longitude and retrieves the tile. System 100 also locates itself on the retrieved tile by understanding the span of the tile in all directions. With this information on hand, system 100 downloads the required tiles from some map providers 208. System 100 is designed to support multiple providers 208, overlay information from one provider 208 on the other. System 100 extends an option to user 200 taking his preferences on what all location providers 208 to use for his navigation.

Another example of customizing positional and navigational information is double buffering technique. System 100 makes use of double buffering technique to give a smooth visual effect on the screen. System 100 creates a canvas, puts in all the details required and displays it to user 200 by painting it on the screen. For updating of the details another canvas is created, the content is updated on that canvas and displayed to user 200.

Another example of customizing positional and navigational information is All Scale Graphics (ASG). System processing includes using a method named as All Scaled Graphics (ASG) to give user 200 a uniform experience across various mobile phones 302. ASG is a part of application 300. Mobile phones 302 differ in their configuration. Each mobile phone has its own features, for example size of display, resolution, font size, etc. ASG is evolved to support all possible graphics. ASG detects vital statistics of mobile phone 302 like the Operating System version, display size, network features, memory available etc. ASG then customizes the information presentation based on the user interface of mobile phone 302. The customizing includes redrawing user interface to suit display size, adding or removing touch screen support, reducing load of application 300 depending upon the computation power available, utilizing all memory options available etc. The abovementioned customization involves application 300 supporting only the desirable mobile phone features from various permutations and combinations of features present within mobile phone 302.

System processing also involves managing efficient utilization of the memory. For example, in case of system 100 being used as a black box as discussed in conjunction with FIG. 1, system 100 can continuously keep recording the audio and/or video conversations for internal processing. The recording is done in a small buffer memory in which a fixed limit is set for the data. In case the recording exceeds the memory limit, the old data is overwritten in circular queue fashion. The recording can be used for detecting accidents. For example, the sudden decrease in speed of the vehicle can be a signal for an accident and this is captured by system 100. Moreover, in the case of an accident, the system stops overwriting the data, instead continuously records till the memory is full. In case of limitation to the memory usage, system 100 caches the MFU (Most Frequently Used) or the least recently used maps. The system 100 employs a garbage collection mechanism to remove the maps which, according to system 100, will not be used in the near future. When memory has to be freed, system 100 removes either the least frequently used items or the least recently used items based on the selection of the garbage collection strategy by user 200.

At step 408, location information is shown to user 200 as the output of his/her query with the help of user interface 308 with options for panning, zooming on these maps. System 100 also displays the current location of user 200 on these maps.

Output to user 200 can also be in the form of navigational help. For example, if a family needs tour guiding of a new city, system 100 is capable of assisting them while driving by providing navigational information like visual or voice commands requesting user 200 to follow a particular road, change roads, take turns, etc.

In several cases system 100 finds use with the help of central station 210. Such central station 210 can keep track of several such systems and thus can be helpful in traffic assistance, social networking, emergency services, sharing information etc. This has been explained in detail in conjunction with FIG. 5.

FIG. 5 is a flow chart describing the functioning of several systems like system 100 in connection with central system 100.

At step 502, system 100 collects positional and navigational information. The system also processes the positional and navigational information to get location information. This has been discussed in conjunction with FIG. 4. Hereinafter, the term ‘information’ used in conjunction with FIG. 5 refers to positional information, navigational information and location information.

At step 504, the information collected by system 100 is broadcasted to central station 210. User approval may or may not be necessary for disclosing information to other users 200. For example, in the case of parental monitoring of children, the children approval may not be necessary for sending information to the parents. Another example could be in case of an emergency, when the system 100 automatically detects an emergency situation like an accident and transfer the current location with some history information including their previous travel information to a central station.

At step 506, central station 210 gathers information from several such systems. The information movement from the application 300 within mobile phone 302 to the central station can be using the existing mobile phone data communication infrastructure like GPRS, EDGE, CDMA1X and other upcoming technologies.

For example, in case of using system 100 for social networking, central station 210 will collect information from all the members of the family or all peers who are connected through such systems. In the case of use of system 100 for traffic assistance, central station 210 will receive information from all such mobile phones 302 present in the vehicles running on the roads being monitored. In the case of organizational monitoring system, central station 210 receives information from all its employees carrying system 100. For example, information about the sales representatives on calls for company or the cab drivers on road for cab service can be monitored.

At step 508, central station 210 processes the information collected. For example, in case of traffic assistance, aggregation of information collected will help central station to obtain statistics like number of vehicles taking a particular route, average speed in the particular route etc. In case of social networking, central station 210 can calculate the distance between the family members and the nearest route to reach them etc. In case of an emergency central station can process the sort of help needed. For example, central station 210 can assess whether emergency is due to an accident or fire etc.

At step 510, central station 210 distributes processed information to other systems. The information can be distributed to third parties as well. For example in case of traffic assistance service, the system 100 can inform user 200 of the traffic density in the route being taken. Similarly central station can provide location of family members to other family members, providing location of sales executives to an organizational head, and providing friends with important shared information by a friend like trip data route maps etc.

In the foregoing specification, the invention has been described with reference to specific embodiments thereof. However, various modifications and changes may be made thereto without departing from the broader spirit and scope of the invention. The specification and drawings are, accordingly to be regarded in an illustrative sense rather than a restrictive sense.

What is claimed is:

1. A mobile phone based navigation system capable of processing signals both from GPS satellite and mobile towers to determine location information for a user, the system comprising:
(a) a hand held mobile phone;
(b) a memory;
(c) means for receiving signals, the receiving means capable of processing the signals transmitted from both GPS and mobile towers to obtain positional information for the mobile phone;
(d) means for processing the positional information and navigational information to determine the location information, the processing means obtaining the navigational information from the memory or from an external provider; and,
(e) a user interface for displaying the location information to the user.

2. The system as recited in claim 1, wherein the memory is the mobile phone memory.

3. The system as recited in claim 1, wherein the memory stores the positional, navigational and location information.

4. The system as recited in claim 1, wherein navigational information includes maps, routes to near-by areas, distances to near-by areas, photographs, images, satellite images, key statistics, specialties of current location, places to visit, shops around, emergency services of in and around areas and locations.

5. The system as recited in claim 1, wherein the location information comprises maps stored in the form of tiles applying mercator projection rules.

6. The system as recited in claim 1, wherein the user interface is the display of the mobile phone.

7. The system as recited in claim 1, wherein processing comprises customizing the location information according to the user interface of the mobile phone.

8. The system as recited in claim 1, wherein the user shares the positional information with a third party.

9. The system as recited in claim 1, wherein the user shares the location information with a third party.

10. A mobile phone based navigation system capable of processing signals from a plurality of sources of positional information for locating a user, the system comprising:
(a) a hand held mobile phone;
(b) means for receiving signals, the receiving means capable of processing the signals transmitted from the plurality of sources of positional information to obtain positional information for the mobile phone; and,
(c) means for processing the positional information, the processing means integrating the positional information with navigational information obtained from an external provider and displaying the location to the user through a user interface.

11. A mobile phone based traffic assistance system, the system comprising:
(a) at least one hand held mobile phone;
(b) means for receiving signals, the receiving means capable of processing the signals transmitted from the plurality of sources of positional information to obtain positional information for the mobile phone;
(c) means for processing the positional information, the processing means integrating the positional information with navigational information obtained from an external provider for determining the location information; and,
(d) a central station receiving the location information from the mobile phones, the central station capable of analyzing the location information to determine traffic condition information, the central station transmitting the traffic condition information to the mobile phones for providing traffic assistance.

12. A method for assisting a user in navigation, the user carrying a mobile phone, the method comprising:
(a) collecting positional and navigational information using the mobile phone;
(b) storing the positional and navigational information in memory, wherein the positional and navigational information is stored so as to ensure efficient utilization of the memory;
(c) processing positional and navigational information to obtain location information, wherein the step of processing comprises customizing the positional and navigational information based on user interface of the mobile phone; and,
(d) displaying the location information to the user on the mobile phone, whereby the location information is used by user for navigation.

13. The method as recited in claim 12, wherein navigational information is based on positional information.

14. The method as recited in claim 12, wherein step of collecting positional and/or navigational information is based on navigation related request from the user.

15. The method as recited in claim 12, wherein navigational information is obtained from the mobile phone memory.

16. The method as recited in claim 12, wherein positional information is obtained from GPS.

17. The method as recited in claim 12, wherein positional information is obtained from mobile phone towers.

18. The method as recited in claim 12 further comprises the step of sharing of location information by the user with a third party.
